(19) United States
(12) Patent Application Publication
(10) Pub. No.: US 2022/0379467 A1
(43) Pub. Date: Dec. 1, 2022

(54) ROBOT

(71) Applicant: Panasonic Intellectual Property Management Co., Ltd., Osaka (JP)

(72) Inventor: SHUMPEI UEGAKI, Nara (JP)

(21) Appl. No.: 17/664,666

(22) Filed: May 24, 2022

(30) Foreign Application Priority Data
Jun. 1, 2021 (JP) 2021-092290

(51) Int. Cl. B25J 9/16; B25J 9/00; B25J 15/06; B25J 19/02

(52) U.S. Cl. CPC B25J 9/1612; B25J 9/0009; B25J 15/0616; B25J 19/023

(57) ABSTRACT

A robot includes a robot body, a hand, an arm, and a controller. The hand includes a fixed frame that is fixed to the arm, a first camera that is attached to the fixed frame, a movable frame that is rotatable with respect to the fixed frame, gripping portions that are attached to the movable frame to grip an article having a front surface facing the robot and a back surface opposite to the front surface, and a driver that rotates the movable frame. The gripping portions grip the article in a state where the back surface is opened, and shift from a first state where the article is gripped to a second state where the back surface of the article is able to be captured by the first camera by the rotation of the movable frame.

### BACKGROUND

### 1. Technical Field

The present disclosure relates to a robot, and particularly, to a technique suitable for a robot for automatically performing an in-store work such as display and disposal of products.

### 2. Description of the Related Art

In a retail industry, manpower shortage due to a decrease in working population is serious, but an actual situation is that much of an in-store work for selling products relies on manpower, and automation thereof is required.

Under such circumstances, a mobile robot (hereinafter, referred to as a “mobile manipulator robot”) equipped with a manipulator such as a robot arm or a robot hand has been proposed, and the automation of the in-store work has been attempted gradually.

In particular, it is assumed that a work such as arrangement of display shelves and the display and disposal of products is performed by utilizing a function of moving the mobile manipulator robot and a function of gripping and transferring an object.

For example, PTL 1 discloses a robot that arranges display shelves by detecting disturbance of a display state of products from an image obtained by capturing the display shelves and rearranging the products by using a robot arm when the disturbance is detected.

PTL 2 discloses a workpiece gripping device capable of linearly translating and rotating a gripping portion for gripping a workpiece by 90 degrees.

### CITATION LIST

### Patent Literature

PTL 1: Unexamined Japanese Patent Publication No. 2021-000687
PTL 2: Unexamined Japanese Patent Publication No. 2020-059100

### SUMMARY

A robot according to an aspect of the present disclosure includes a robot body, a hand, an arm that connects the robot body and the hand, and displaces a position and an orientation of the hand, and a controller that controls operations of the hand and the arm. The hand includes a fixed frame that is fixed to the arm, a first camera that is attached to the fixed frame, a movable frame that is rotatable with respect to the fixed frame, gripping portions that are attached to the movable frame to grip an article having a front surface facing the robot and a back surface opposite to the front surface, and a driver that rotates the movable frame, and the gripping portions grip the article in a state where the back surface is opened, and shift from a first state where the article is gripped to a second state where the back surface of the article is able to be captured by the first camera by the rotation of the movable frame.

### BRIEF DESCRIPTION OF THE DRAWINGS

FIG. 1 is an overall view of a robot according to an exemplary embodiment;

FIG. 2 is a block diagram illustrating a configuration of a control system in the robot;

FIG. 3 is a side view of a hand;

FIG. 4 is a side view of the hand;

FIG. 5 is a block diagram illustrating a configuration of a vacuum piping system in the robot;

FIGS. 6A to 6C are perspective views illustrating a scene in which a movable frame rotates; and

FIG. 7 is a flowchart illustrating an example of imaging processing of a product label.

### DETAILED DESCRIPTIONS

In the technique of PTL 1, the display shelf is captured by a camera attached to a robot body, and it is possible to detect the disturbance of the products in the display shelf, but it is difficult to recognize individual products. For example, the product label used for recognizing the individual product is usually attached to a back surface of the product invisible from the front of the display shelf in many cases. In this case, after the robot grips the product to capture the product label, a large arm operation in which the product is directed to the robot side and is simultaneously brought close to the camera is required. Thus, a calculation load for searching for a route of the arm operation increases, and an operation tact also becomes long. It may be difficult to secure an operation space for avoiding surrounding obstacles.

In the technique of PTL 2, a rotation mechanism for changing a direction of the workpiece gripping portion is provided, but an operation range of the rotation is insufficient, and even though the direction of the gripping portion is rotated after the product is gripped, the back surface of the product cannot be captured. As a result, the arm operation is required.

An object of the present disclosure is to provide a robot that can safely reverse a direction of an article at a high speed and can capture a back surface of the article to be captured.

Hereinafter, an exemplary embodiment of the present disclosure will be described in detail with reference to the drawings. The same components are denoted by the same reference marks. In the present exemplary embodiment, a display and disposal robot that performs an in-store work such as displaying and discarding of products in a store or the like will be described.

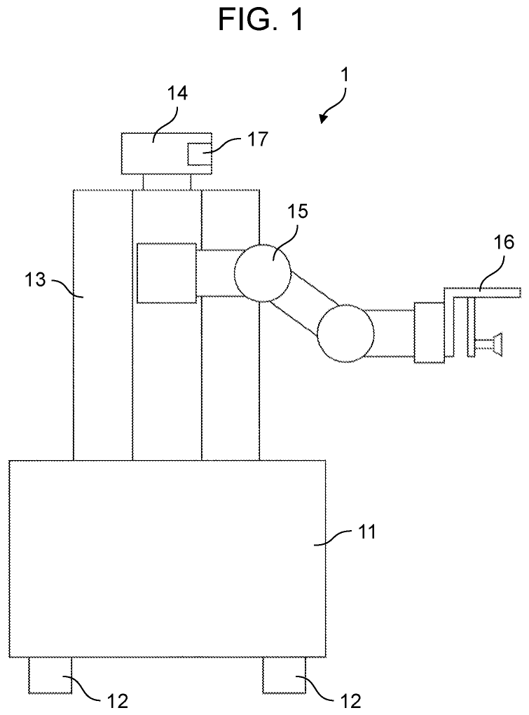

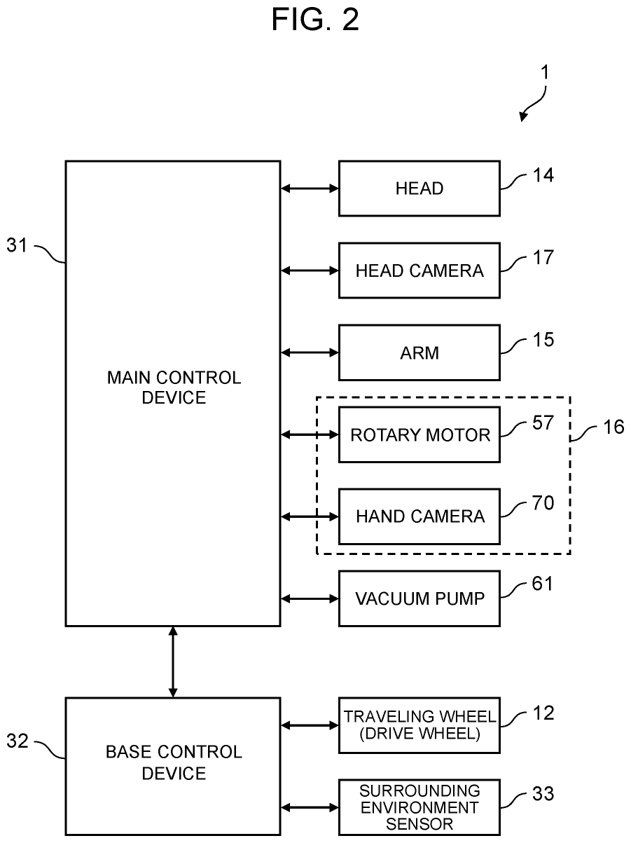

FIG. 1 is an overall view of robot 1 according to the exemplary embodiment. FIG. 2 is a block diagram illustrating a configuration of a control system in robot 1.

As illustrated in FIG. 1, robot 1 includes robot base 11, traveling wheels 12, robot body 13, head 14, arm 15, hand 16, head camera 17, and the like. Robot 1 has a function of capturing a product label attached to a front surface or a back surface of a product and a function of acquiring expiration date information (for example, best-before date information) included in the product label based on the captured image when the product is displayed and discarded.

Robot base 11 is a traveling body that enables robot 1 to autonomously travel. Robot base 11 incorporates a battery (not illustrated) that is a drive source of robot 1, base control device 32 that performs control regarding the autonomous traveling of robot 1, surrounding environment sensor 33, and the like.

Traveling wheels 12 mainly include a plurality of drive wheels. Traveling wheels 12 are installed to support robot base 11. It is desirable that traveling wheels 12 be arranged to sandwich a position of the center of gravity of robot 1. Robot 1 autonomously travels by the rotation of traveling wheels 12. The drive wheels of traveling wheels 12 are driven and controlled by base control device 32. Traveling wheels 12 may have driven wheels in addition to the drive wheels.

Robot body 13 is installed on an upper portion of robot base 11. Head 14 and arm 15 are attached to robot body 13. Robot body 13 includes a vertical slider mechanism (not illustrated) and the like for controlling a height direction of arm 15. Robot body 13 incorporates main control device 31, vacuum pump 61, and the like.

Head 14 is attached to an upper portion of robot body 13. Head 14 is rotationally driven, for example, in a horizontal direction and a vertical direction according to the control of main control device 31.

Arm 15 is a so-called articulated arm, and is attached to robot body 13 via a vertical slider mechanism (not illustrated). A three-dimensional position and orientation of hand 16 connected to a distal end can be displaced by an operation of arm 15.

Hand 16 is a portion that grips a product. In the present exemplary embodiment, hand 16 includes a so-called suction hand to which suction nozzles 40 (or suction pads) is applied. A detailed configuration of hand 16 will be described later.

Head camera 17 is fixed to head 14. Head camera 17 captures an imaging region in front of the camera under the control of main control device 31. In the captured image, an image of a surrounding environment of robot 1 is drawn. An imaging direction of head camera 17 is controlled by the rotation of head 14. Head camera 17 has a function of acquiring three-dimensional distance information in order to improve the recognition accuracy of the surrounding environment. For example, a time of flight (TOF) sensor capable of acquiring an RGB (red, green, and blue) image and a distance image is suitable for head camera 17.

Head camera 17 may be provided such that the entire surrounding environment of robot 1 can be viewed. For example, another frame for holding head camera 17 may be added to robot base 11 or robot body 13, and head camera 17 may be attached to a portion different from head 14. In this case, it is desirable that a rotation mechanism be added such that a direction of head camera 17 is changed.

Main control device 31 controls the overall operation of robot 1. Base control device 32 performs control regarding the traveling of robot 1. Main control device 31 and base control device 32 are connected to each other, and are configured to be able to transmit and receive various kinds of data.

Although not illustrated, main control device 31 and base control device 32 include a central processing unit (CPU) as a calculation and control device, a read only memory (ROM) as a primary storage device, a random access memory (RAM), and the like. The ROM stores a basic program and basic setting data. The CPU centrally controls an operation of each block of robot 1 by reading a program corresponding to a processing content from the ROM, loading the program into the RAM, and executing the developed program.

A part or all of the processing executed by main control device 31 and base control device 32 may be executed by an electronic circuit such as a digital signal processor (DSP), an application specific integrated circuit (ASIC), or a programmable logic device (PLD) provided in accordance with the processing.

Main control device 31 is connected to head 14, arm 15, hand 16, vacuum pump 61, and the like. Main control device 31 can bidirectionally transmit and receive data to and from each connected block.

For example, main control device 31 performs processing of recognizing a product and a surrounding environment necessary for a display and disposal work based on the RGB image and the distance image acquired by head camera 17. For example, main control device 31 controls arm 15 and hand 16 based on the result of the recognition processing, and performs processing of capturing a product label attached to a back surface of the product and processing of displaying or discarding the product based on expiration date information included in the product label.

Base control device 32 creates a map of the surrounding environment based on, for example, surrounding environment information acquired by surrounding environment sensor 33. Base control device 32 predicts the position of robot 1 and the posture of robot 1 on the map based on the surrounding environment information acquired from surrounding environment sensor 33 during autonomous traveling. Base control device 32 controls traveling wheels 12 to cause robot 1 to autonomously travel.

Surrounding environment sensor 33 is a sensor that two-dimensionally or three-dimensionally measures the surrounding environment (for example, an obstacle such as a wall) of robot 1. For example, a laser range finder (LRF) which is a laser range sensor using reflection of laser light can be applied as surrounding environment sensor 33.

In the present exemplary embodiment, robot base 11 and robot body 13 are provided, as separate components, and are provided with each control device. However, these components may be constructed as one module, and main control device 31 and base control device 32 may be shared by one control device.

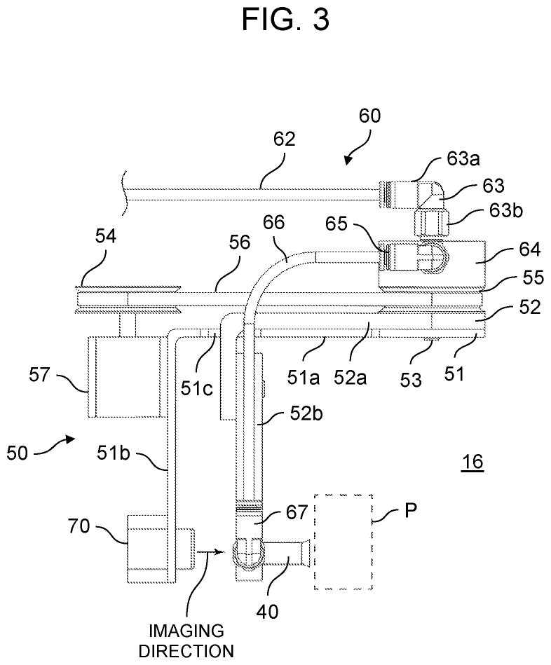

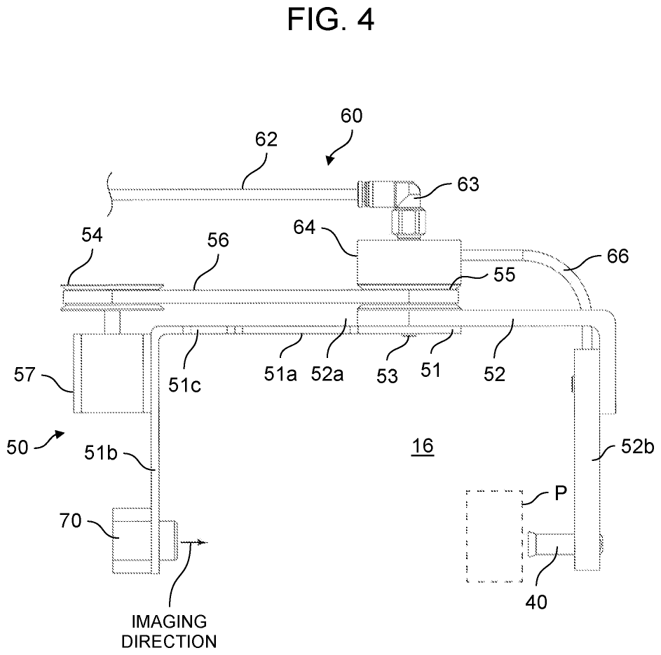

FIGS. 3 and 4 are side views illustrating a configuration of hand 16. FIG. 3 illustrates a reference state where movable frame 52 is closed with respect to fixed frame 51 and is rotated by 0°, and FIG. 4 illustrates a state where movable frame 52 is rotated by 180° and opened.

Hand 16 is normally in the reference state illustrated in FIG. 3 when product P is gripped, and is in the state illustrated in FIG. 4 when the back surface of gripped product P is captured. Hand 16 can grip product P even in a state other than the reference state (for example, the state illustrated in FIG. 4).

As illustrated in FIGS. 3 and 4, hand 16 includes suction nozzles 40 (gripping portions) that grip product P, support mechanism 50 that supports suction nozzles 40 in a displaceable manner, vacuum piping system 60 that connects suction nozzles 40 and vacuum pump 61, hand camera 70, and the like.

Hand camera 70 is a general imaging device, and captures a front imaging region and acquires an RGB image under the control of main control device 31. Hand camera 70 is used, for example, when a product label attached to product P is captured. Hand camera 70 is fixed to second fixed frame 51b of fixed frame 51. The captured image captured by hand camera 70 is transmitted to main control device 31 and is used, for example, for the recognition of the product label.

In the reference state illustrated in FIG. 3, second movable frame 52b is positioned in an imaging direction of hand camera 70, and the surrounding environment cannot be captured. On the other hand, in the state illustrated in FIG. 4 in which movable frame 52 is rotated by 180°, product P gripped by suction nozzles 40 is positioned in the imaging direction of hand camera 70. Since suction nozzles 40 are sucked to the front surface of product P to grip product P, the back surface of product P faces hand camera 70.

Suction nozzles 40 are fixed to second movable frame 52b of movable frame 52. In the present exemplary embodiment, a pair of suction nozzles 40 is provided horizontally toward the inside. Suction nozzles 40 are connected to vacuum piping system 60, and attract and grip the product facing suction nozzle 40 by evacuation of vacuum piping system 60.

Support mechanism 50 includes fixed frame 51, movable frame 52, rotary shaft 53, first pulley 54, second pulley 55, belt 56, rotary motor 57, and the like.

Fixed frame 51 includes first fixed frame 51a extending in the imaging direction of hand camera 70, and second fixed frame 51b bent in a substantially L-shape and extending from one end portion of first fixed frame 51a.

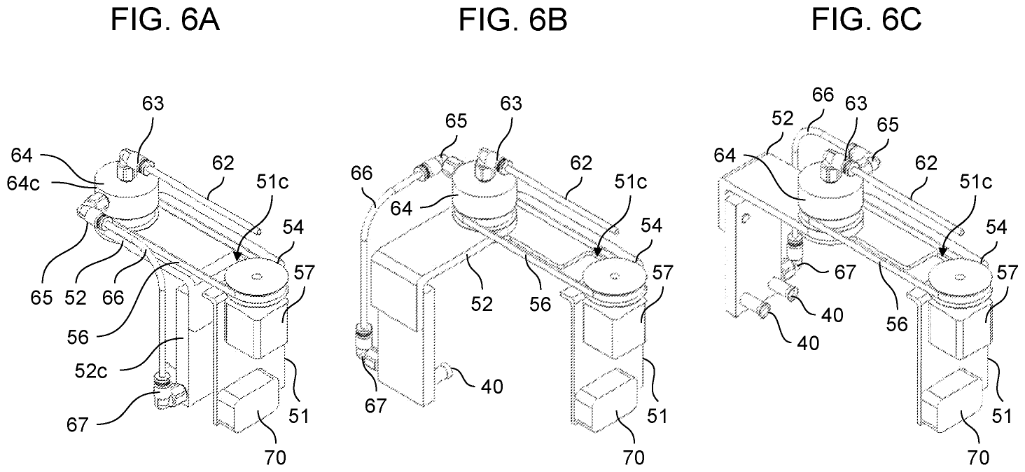

First fixed frame 51a rotatably supports movable frame 52 via rotary shaft 53. First fixed frame 51a has U-shaped notch 51c near a connection portion (bent portion) with second fixed frame 51b, and second movable frame 52b of movable frame 52 is accommodated in the reference state (see FIG. 6A).

Second fixed frame 51b is fixed to arm 15. Hand camera 70 is attached to a lower end portion of second fixed frame 51b such that the imaging direction is directed inward, and rotary motor 57 is attached to an upper end portion.

Movable frame 52 includes first movable frame 52a extending in the imaging direction of hand camera 70, and second movable frame 52b bent in a substantially L-shape and extending from one end portion of first movable frame 52a.

First movable frame 52a is supported by fixed frame 51 via rotary shaft 53. First movable frame 52a is disposed on an upper surface of first fixed frame 51a. First movable frame 52a is fixed to rotary shaft 53 and rotates in accordance with the rotation of rotary shaft 53.

Suction nozzles 40 are attached to a lower end portion of second movable frame 52b. Positions of suction nozzles 40 in a vertical direction are the same as a position of hand camera 70. Nozzle-side joint 67 is fixed to a side surface by using, as a front surface, a surface of second movable frame 52b to which suction nozzles 40 are fixed. A frame flow path (not illustrated) communicating with nozzle-side joint 67 and suction nozzles 40 is provided inside second movable frame 52b.

Rotary shaft 53 is attached to the end portion of first fixed frame 51a via a bearing (not illustrated). Rotary shaft 53 is designed to be able to support a load in a thrust direction such that rotary shaft 53 does not fall off from first fixed frame 51a. Movable frame 52 (first movable frame 52a), second pulley 55, and rotation base 64 are inserted through and fixed to rotary shaft 53 in this order from fixed frame 51 side.

Rotary motor 57 is a drive source that rotates movable frame 52 with respect to fixed frame 51. Rotary motor 57 is fixed to the upper end portion of second fixed frame 51b of fixed frame 51. First pulley 54 is fixed to a motor shaft of rotary motor 57. In FIGS. 3 and 4, rotary motor 57 is directly fixed to fixed frame 51, but may be fixed to fixed frame 51 via a member different from fixed frame 51.

First pulley 54 is fixed to the motor shaft of rotary motor 57, and second pulley 55 is fixed to rotary shaft 53. Belt 56 is stretched around first pulley 54 and second pulley 55, and a power of rotary motor 57 is transmitted to second pulley 55 via belt 56. Thus, when the motor shaft of rotary motor 57 rotates, first pulley 54 rotates, and second pulley 55 simultaneously rotates in the same direction. With the rotation of second pulley 55, rotary shaft 53 rotates, and movable frame 52 fixed to rotary shaft 53 also rotates in the same direction.

Vacuum piping system 60 includes first vacuum tube 62, robot-body-side joint 63, rotation base 64, base-side joint 65, second vacuum tube 66, nozzle-side joint 67, and the like. FIG. 6 schematically illustrates a configuration of vacuum piping system 60.

First vacuum tube 62 is a pipe interposed between vacuum pump 61 built in robot body 13 and rotation base 64. Second vacuum tube 66 is a pipe interposed between rotation base 64 and movable frame 52. First vacuum tube 62 may not be directly connected to vacuum pump 61, and may be connected to vacuum pump 61 via another member.

Rotation base 64 is fixed to rotary shaft 53 and rotates together with rotary shaft 53, that is, together with movable frame 52. A base flow path (not illustrated) communicating with robot-body-side joint 63 and base-side joint 65 is provided inside rotation base 64.

Robot-body-side joint 63 connects first vacuum tube 62 and a base flow path of rotation base 64. Robot-body-side joint 63 is disposed on an extension of rotary shaft 53 on an upper surface of rotation base 64.

Robot-body-side joint 63 includes a rotary joint having housing 63a connected to first vacuum tube 62 and shaft 63b rotatable with respect to housing 63a. Shaft 63b of robot-body-side joint 63 is fixed to rotation base 64. When rotation base 64 rotates, housing 63a to which first vacuum tube 62 is connected does not rotate, and only shaft 63b fixed to rotation base 64 rotates.

Base-side joint 65 connects the base flow path of rotation base 64 and second vacuum tube 66. Nozzle-side joint 67 connects second vacuum tube 66 and a frame flow path of movable frame 52.

Base-side joint 65 and nozzle-side joint 67 are L-shaped joints, and are arranged on a side surface on the same side of rotation base 64 and movable frame 52, respectively. Specifically, base-side joint 65 and nozzle-side joint 67 are arranged on the side surfaces exposed to the outside of rotation base 64 and movable frame 52 in the reference state.

Second vacuum tube 66 connecting base-side joint 65 and nozzle-side joint 67 extends along the side surface of movable frame 52. That is, second vacuum tube 66 is disposed not to hinder a rotation operation of movable frame 52 and to have a length as short as possible.

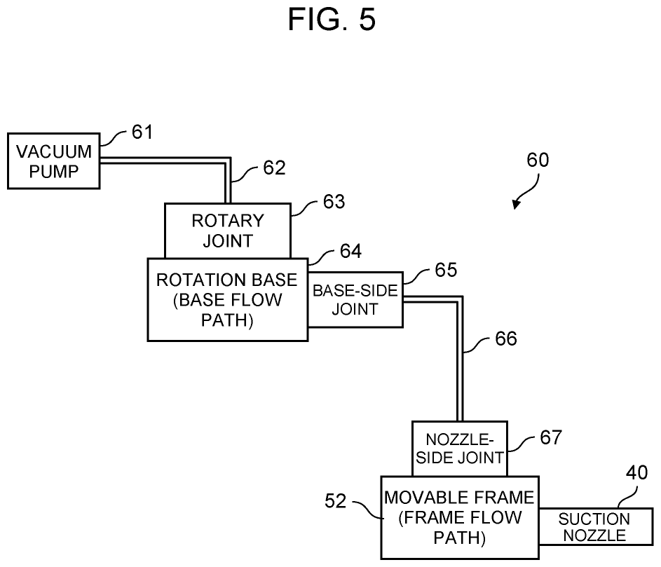

As illustrated in FIG. 5, suction nozzles 40 are connected to vacuum pump 61 via vacuum piping system 60. A suction force (attraction force) of suction nozzles 40 is generated by drawing air by vacuum pump 61. Specifically, when vacuum pump 61 is turned on and evacuation is started, air is drawn in from distal ends of suction nozzles 40. As a result, product P positioned near the distal ends of suction nozzles 40 is sucked and gripped by suction nozzles 40. The ON and OFF control of vacuum pump 61 is performed by main control device 31.

FIGS. 6A to 6C are perspective views illustrating a scene in which movable frame 52 rotates. FIG. 6A illustrates a reference state where movable frame 52 does not rotate but rotates by 0°, FIG. 6B illustrates a state where movable frame 52 rotates by 90°, and FIG. 6C illustrates a state where movable frame 52 rotates by 180°. In FIGS. 6A to 6C, a rotation direction of movable frame 52 is opposite to the rotation direction in FIGS. 3 and 4. Thus, a side surface on which second vacuum tube 66 and the like are disposed is also opposite to the side surface in FIGS. 3 and 4.

As illustrated in FIG. 6A, in the reference state, movable frame 52 is accommodated inside the fixed frame such that second movable frame 52b enters notch 51c of first fixed frame 51a, and first movable frame 52a and first fixed frame 51a overlap each other. At this time, second movable frame 52b of movable frame 52 is positioned in front of hand camera 70, and the imaging direction is blocked.

As illustrated in FIG. 6B, when movable frame 52 rotates 90° from the reference state, second movable frame 52b moves from the front of hand camera 70. As a result, the imaging direction of hand camera 70 is opened, and the product and the surrounding environment can be captured by hand camera 70.

As illustrated in FIG. 6C, when movable frame 52 rotates 180° from the reference state, suction nozzles 40 face the front of hand camera 70. At this time, the back surface of product P faces hand camera 70. As a result, the back surface of product P gripped by suction nozzles 40 can be captured by hand camera 70.

As illustrated in FIGS. 6A to 6C, movable frame 52 rotates in a horizontal direction along a surface of first fixed frame 51a of fixed frame 51. Accordingly, the rotation operation of movable frame 52 can be stabilized as compared with the case where the movable frame rotates in a vertical direction.

Since robot-body-side joint 63 is constructed by a rotary joint, the orientation of first vacuum tube 62 does not change even when movable frame 52 rotates. Since base-side joint 65 and nozzle-side joint 67 are arranged on the same side with respect to movable frame 52 and rotate while maintaining a mutual positional relationship when movable frame 52 rotates, the orientation of second vacuum tube 66 does not change.

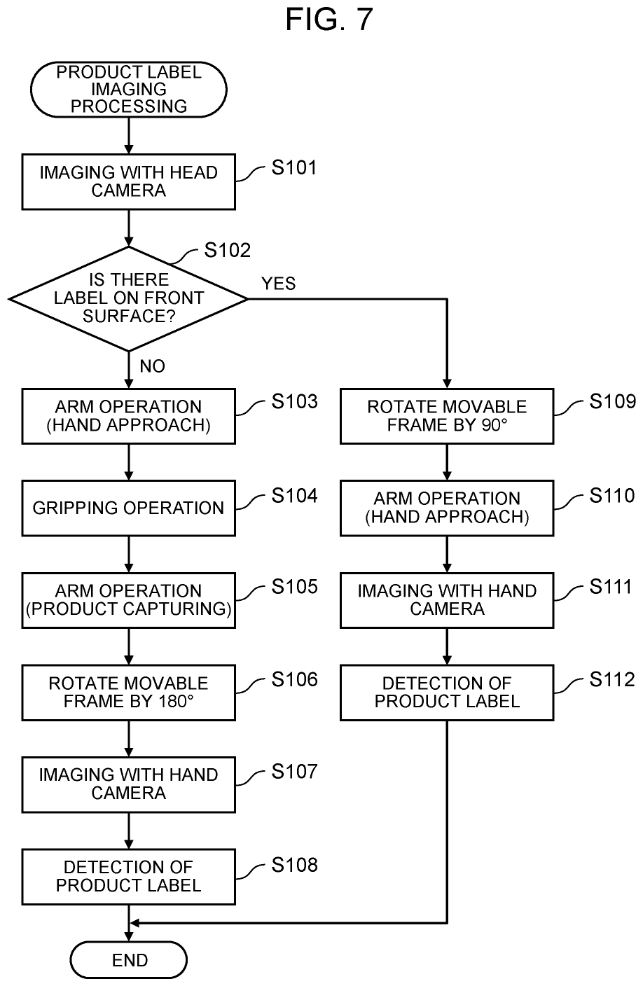

FIG. 7 is a flowchart illustrating an example of imaging processing of the product label. This processing is realized, for example, by the CPU of main control device 31 executing a predetermined program stored in the ROM after robot 1 autonomously travels in front of a target product.

First, in step S101 of FIG. 7, main control device 31 captures a display shelf with head camera 17 and acquires the captured image in order to determine whether the product label is attached to the front surface or the back surface of the product. Here, a side on which a consumer can visually recognize a product mainly in a state where the product is displayed is a front surface of the product. Normally, there are two patterns of product labels, that is, a product label attached to the front surface and a product label attached to the back surface of a product.

In step S102, main control device 31 detects a target product based on the captured image captured by head camera 17. Main control device 31 determines whether the product label is attached to the front surface of the detected product. Detection processing of the product and the front-back determination processing of the product label are performed, for example, by an algorithm using an object detection model using deep learning.

In step S102, in addition to the detection processing of the product and the front-back determination processing of the product label, the three-dimensional position and orientation of the product are also recognized. An algorithm using a position and orientation recognition model using deep learning can also be applied to this recognition processing.

In step S102, when it is determined that the product label is attached to the front surface of the product (“YES” in step S102), the processing proceeds to step S109, and the processing of steps S109 to S112 is executed. On the other hand, when it is determined that the product label is not attached to the front surface of the product (“NO” in step S102), the processing proceeds to step S103, and the processing of steps S103 to S108 is executed. As described above, in the imaging processing of the product label, different processing is performed depending on an attachment position of the product label (the front surface or the back surface of the product).

When the product label is not attached to the front surface of the product, in step S103, main control device 31 controls the operation of arm 15 based on the three-dimensional position and orientation of the product recognized in step S102 to obtain an appropriate gripping position, and moves hand 16 to the front of the product.

In step S104, main control device 31 operates vacuum pump 61 such that air is sucked from suction nozzles 40. Thereafter, main control device 31 controls the operation of arm 15 to bring the product close to suction nozzle 40 and suck and grip the product.

After it is confirmed that the product is gripped, in step S105, main control device 31 controls the operation of arm 15 to, for example, draw the product obliquely upward and forward and take out the product from the display shelf. At this time, the position of hand 16 is adjusted such that movable frame 52 can be rotated without interference between hand 16 and a surrounding object.

When the arm operation in step S105 is ended, in step S106, main control device 31 operates rotary motor 57 to rotate movable frame 52 by 180°. When movable frame 52 rotates 180°, the back surface of the gripped product faces hand camera 70.

In step S107, main control device 31 causes hand camera 70 to capture the back surface of the gripped product. Since the product is positioned near hand camera 70, the back surface of the product can be clearly captured. It is not necessary to operate arm 15 to move the gripped product to near head camera 17.

In step S108, main control device 31 detects the product label based on the captured image captured by hand camera 70. Main control device 31 displays (returns) or discards the product in accordance with the expiration date information included in the detected label.

When the product label is attached to the front surface of the product, in step S109, main control device 31 operates rotary motor 57 to rotate movable frame 52 by 90°.

In the reference state where movable frame 52 of hand 16 does not rotate (see FIG. 4A), since movable frame 52 and other parts enter the imaging region of hand camera 70, it is difficult to capture the front surface of the product with hand camera 70. Thus, in step S109, movable frame 52 is rotated to open the imaging direction of hand camera 70.

A rotation angle of movable frame 52 in step S109 may not be 90°. That is, movable frame 52 may be rotated by the arm operation in step S110 such that the product label enters the imaging region of hand camera 70. The rotation angle of movable frame 52 is set as small as possible within a range, for example, from 0° to 90° inclusive.

In step S110, main control device 31 controls the operation of arm 15 such that the front surface of the product falls within an angle of view of hand camera 70 while maintaining a state where the product can be captured by hand camera 70. At this time, it is desirable that the product and hand camera 70 be as close as possible within a range in which arm 15 and hand 16 do not interfere with the surrounding environment.

In step S111, main control device 31 captures the front surface of the product with hand camera 70 in the same manner as in step S107.

In step S112, main control device 31 detects the product label based on the captured image captured by hand camera 70, and displays or discards the product based on the detection result, in the same manner as in step S108.

As described above, robot 1 according to the present exemplary embodiment includes robot body 13, hand 16, arm 15 that connects robot body 13 and hand 16 and displaces the position and the orientation of hand 16, and main control device 31 (controller) that controls the operations of hand 16 and arm 15. Hand 16 includes fixed frame 51 fixed to arm 15, hand camera 70 (first camera) attached to fixed frame 51, movable frame 52 rotatable with respect to fixed frame 51, suction nozzles 40 (gripping portions) attached to movable frame 52 to grip product P (article) having the front surface facing robot 1 and the back surface opposite to the front surface, and a driver such as rotary motor 57 that rotates movable frame 52. Suction nozzles 40 (gripping portions) grip product P in a state where the back surface is opened, and shifts from a first state (see FIG. 6A) in which product P is gripped to a second state (see FIG. 6C) in which the back surface of product P can be captured by hand camera 70 by the rotation of movable frame 52.

According to robot 1, in the imaging processing of the product label, the direction of the product can be reversed by merely rotating movable frame 52 of hand 16, and the product label attached to the front surface or the back surface of the product can be efficiently captured.

Accordingly, the in-store work involving the imaging processing of the product label such as the display and disposal work can be executed at high speed. Since there is no large arm operation, a risk of collision with a surrounding environmental object is greatly reduced, and safety is significantly improved.

In robot 1, hand 16 further includes rotary shaft 53 provided on fixed frame 51, and movable frame 52 includes first movable frame 52a that extends in the imaging direction and is attached to fixed frame 51 via rotary shaft 53, and second movable frame 52b that is bent in a substantially L-shape and extending from first movable frame 52a. Suction nozzles 40 (gripping portions) are attached to second movable frame 52b, and movable frame 52 rotates about rotary shaft 53 perpendicular to first movable frame 52a.

That is, movable frame 52 rotates in a horizontal direction along the surface of first fixed frame 51a of fixed frame 51. Accordingly, the rotation operation of movable frame 52 is stabilized as compared with the case where the movable frame rotates in a vertical direction.

In robot 1, second movable frame 52b is positioned closer to rotary shaft 53 than hand camera 70 (first camera) in a radial direction orthogonal to rotary shaft 53.

As a result, since movable frame 52 is accommodated to overlap with fixed frame 51 in the reference state as illustrated in FIG. 6A, hand 16 can be compact.

In robot 1, the gripping portions of hand 16 are suction nozzles 40 that attract and grip product P (article), and hand 16 further includes vacuum piping system 60 that connects vacuum pump 61 provided in robot body 13 and suction nozzle 40.

As a result, product P can be easily gripped and reversed in a state where the back surface is opened.

In robot 1, vacuum piping system 60 includes rotation base 64 that is attached to first movable frame 52a and rotates together with movable frame 52, first vacuum tube 62 that is interposed between vacuum pump 61 and rotation base 64, second vacuum tube 66 that is interposed between rotation base 64 and movable frame 52, robot-body-side joint 63 that connects first vacuum tube 62 and the base flow path provided in rotation base 64, base-side joint 65 that connects the base flow path and second vacuum tube 66, and nozzle-side joint 67 that connects second vacuum tube 66 and the frame flow path provided in second movable frame 52b. Suction nozzles 40 are connected to the frame flow path.

As a result, in hand 16 having the rotation mechanism of movable frame 52, vacuum piping system 60 that is not affected by the rotation operation of movable frame 52 can be realized.

In robot 1, robot-body-side joint 63 is a rotary joint having the housing connected to first vacuum tube 62 and the shaft that rotates with respect to the housing when rotation base 64 rotates.

In robot 1, base-side joint 65 and nozzle-side joint 67 are arranged on first side surface 64c of rotation base 64 and second side surface 52c on the same side as first side surface 64c of movable frame 52, respectively, and second vacuum tube 66 extends along second side surface 52c of movable frame 52.

As a result, it is possible to prevent vacuum piping system 60 from hindering the rotation operation of movable frame 52. Since the orientations of first vacuum tube 62 and second vacuum tube 66 are maintained regardless of the rotation operation of movable frame 52, first vacuum tube 62 and second vacuum tube 66 are not twisted and damaged by the rotation operation of movable frame 52.

Robot 1 includes head camera 17 (second camera) attached to head 14, and main control device 31 (controller) determines whether the label is attached to the front surface of product P (article) based on the image acquired by head camera 17, and causes hand camera 70 (first camera) to capture the back surface of product P by operating arm 15 and hand 16 when the label is not attached to the front surface of product P.

As a result, the imaging processing of the product label can be efficiently executed, and the product label is captured by hand camera 70 present near product P. Thus, a clear captured image can be acquired, and the recognition accuracy of the product label is improved.

In robot 1, main control device 31 (controller) can freely control the rotation of movable frame 52 between 0° and 180°, inclusive.

As a result, when the product label is attached to the front surface of product P, movable frame 52 can be moved with a minimum operation in accordance with the surrounding environment, and the product label can be captured by hand camera 70.

Although the disclosure by the inventor of the present invention has been specifically described above based on the exemplary embodiment, the present disclosure is not limited to the above exemplary embodiment, and can be modified without departing from the spirit of the present disclosure.

For example, in the exemplary embodiment, suction nozzles 40 are applied as an example of the gripping portions for gripping the article, but the configuration of the gripping portions is not limited thereto. The gripping portions may grip the article in a state where the back surface of the article is opened. For example, the gripping portions may be configured to grip the article by sandwiching the article between both side surfaces of the article with a pair of plates. In the above exemplary embodiment, the gripping portions (suction nozzles 40) suck the front surface of the article, but does not suck the back surface of the article. The back surface of the article is visible without being hidden by the gripping portions and other parts. That is, the back surface of the article is opened.

It should be construed that the exemplary embodiment disclosed herein is illustrative in all aspects, and is not restrictive. The scope of the present disclosure is represented by the scope of the claims and not by the above description, and it is intended that all modifications within the sense and scope equivalent to the claims are involved in the scope of the present disclosure.

According to the robot of the present disclosure, it is possible to capture the back surface by reversing the direction of the article to be captured at high speed and safely.

The robot of the present disclosure can be applied to a robot that performs a work that requires capturing not only a front surface but also a back surface of an article, such as detection of a product label in a display and disposal work.

What is claimed is:

1. A robot comprising:
a robot body;
a hand;
an arm that connects the robot body and the hand, and displaces a position and an orientation of the hand; and
a controller that controls operations of the hand and the arm,
wherein the hand includes
a fixed frame that is fixed to the arm,
a first camera that is attached to the fixed frame,
a movable frame that is rotatable with respect to the fixed frame,
gripping portions that are attached to the movable frame to grip an article having a front surface facing the robot and a back surface opposite to the front surface, and
a driver that rotates the movable frame, and
the gripping portions grip the article in a state where the back surface is opened, and shift from a first state where the article is gripped to a second state where the back surface of the article is able to be captured by the first camera by the rotation of the movable frame.

2. The robot according to claim 1,
wherein the hand further includes a rotary shaft provided in the fixed frame,
the movable frame has a first movable frame extending in an imaging direction and attached to the fixed frame via the rotary shaft and a second movable frame bent in a substantially L-shape and extending from the first movable frame,
the gripping portions are attached to the second movable frame, and
the movable frame rotates about the rotary shaft perpendicular to the first movable frame.

3. The robot according to claim 2, wherein the second movable frame is positioned closer to the rotary shaft than the first camera in a radial direction orthogonal to the rotary shaft.

4. The robot according to claim 3, wherein the gripping portions are suction nozzles that attract the article to grip the article, and
the hand further includes a vacuum piping system that connects a vacuum pump provided in the robot body and the suction nozzles.

5. The robot according to claim 4,
wherein the vacuum piping system includes
a rotation base that is attached to the first movable frame, and rotates together with the movable frame,
a first vacuum tube that is interposed between the vacuum pump and the rotation base,
a second vacuum tube that is interposed between the rotation base and the movable frame,
a robot-body-side joint that connects the first vacuum tube and a base flow path provided in the rotation base,
a base-side joint that connects the base flow path and the second vacuum tube, and
a nozzle-side joint that connects the second vacuum tube and a frame flow path provided in the second movable frame, and
the suction nozzles are connected to the frame flow path.

6. The robot according to claim 5, wherein the robot-body-side joint is a rotary joint that has a housing connected to the first vacuum tube and a shaft that rotates with respect to the housing when the rotation base rotates.

7. The robot according to claim 6, wherein the base-side joint and the nozzle-side joint are arranged on a first side surface of the rotation base and a second side surface on the same side as the first side surface of the movable frame, respectively, and
the second vacuum tube extends along the second side surface of the movable frame.

8. The robot according to claim 1, further comprising:
a second camera that is attached to the robot body, and
the controller determines whether or not a label is attached to the front surface of the article based on an image acquired by the second camera, and
operates the arm and the hand and causes the first camera to capture the back surface of the article when the label is not attached to the front surface of the article.

9. The robot according to claim 1, wherein the controller is configured to freely control the rotation of the movable frame between 0° to 180°, inclusive.
